(19) United States
(12) Patent Application Publication
(10) Pub. No.: US 2018/0020057 A1
(43) Pub. Date: Jan. 18, 2018

(54) Method and System for Connecting Heterogeneous Internet of Things Devices for Workflow Automation

(71) Applicant: Simon G. M. Koo, San Jose, CA (US)

(72) Inventor: Simon G. M. Koo, San Jose, CA (US)

(73) Assignee: Ananse Incorporated, San Jose, CA (US)

(21) Appl. No.: 15/208,298

(22) Filed: Jul. 12, 2016

(51) Int. Cl. H04L 29/08; H04L 12/26; G06F 9/54; H04L 29/06; G06F 9/48

(52) U.S. Cl. CPC H04L 67/125; H04L 63/0876; G06F 9/4881; G06F 9/547; H04L 43/10

(57) ABSTRACT

A method and computer program product of an Internet of Things (IoT) platform for workflow automation of heterogeneous IoT devices. The platform is implemented as a cloud service, and the IoT devices are connected to the platform via application programming interfaces. The platform allows end-users to reduce the need of substantial human involvement, and migrate to a streamlined, trigger-driven automatic decision making operation model for IoT workflows. The method includes steps of connecting an IoT platform to heterogeneous IoT devices; defining IoT workflows with the devices; decomposing the workflows into sequence of event-triggering tasks; polling the tasks over a predefined frequency; detecting whether triggering condition(s) of executing the tasks is met; and requesting the devices to perform the tasks, whereby no human interventions are necessary during the executions.

### FIELD OF THE INVENTION

The present invention relates generally to the field of Internet of Things and smart device automation. In particular the present invention relates to a method and system for connecting heterogeneous Internet of Things devices and integrate them for interoperability and workflow automation.

### BACKGROUND OF THE INVENTION

The Internet is a global system of interconnected computers and computer networks, using protocol suites such as the the Transmission Control Protocol and Internet Protocol (TCP/IP) as standards for communications. The Internet of Things (IoT) is a technology revolution which extends the idea by interconnecting smart sensor and actuator devices that can exchange data over the Internet. With the IoT, the two-dimensional communication provided by the Internet—any time and anywhere—has evolved into a three-dimensional model by a new dimension: anything. This new dimension has created a new and blooming market for novel smart devices aiming to extend the capability of the Internet.

Many IoT devices on the market have a dedicated app for device control and management over the Internet, but there are no unified IoT standards for heterogenous machine-to-machine communication. Devices of different brands and those manufactured by different vendors may run different communication protocols, and they may not be able to interoperate with each other.

A group of homogeneous devices usually interoperate well together because there is no incompatibility issue. For multiple heterogeneous IoT devices, connecting them together is inevitably constrained. Existing methods and systems can organize these devices into groups for efficient iteration and management in a local-area network setting by first connecting them to a hub or a super-agent, given that each of the devices run on compatible medium access protocols. Such local groupings allow the devices to work together and provide local-area interoperability for individuals, in solutions such as smart health and smart home. In order to provide larger scale and wide-area solutions such as smart enterprise or smart city, homogeneous devices or devices running on compatible connection and communication protocols must be used.

Some IoT device vendors provide device-specific cloud services which may offer application programming interfaces (APIs) to enable third-party applications to connect to and control the devices. Through the use APIs, it is possible to build heterogeneous IoT device workflows, in which the devices communicate and collaborate with each other over wide-area networks. The integration software needs to be dedicated, and has to be written explicitly for each particular workflow because of the tight associations between devices and their corresponding APIs. This API-based software structure also enables physical IoT devices to communicate and collaborate with software “things” such as social media and instant messaging applications, via their corresponding APIs if available.

Various IoT integration platforms are created for different purposes such as facilitating data consolidation and capability integration. These platforms can turn a dispersed group of heterogeneous IoT devices into a collection of devices that can be managed by a centralized entity, making the platforms behave like a universal Internet remote control for the devices. End-users can control the devices they owned and receive notifications generated by those devices. In order to achieve device interoperability with these platforms, end-users will need to act as an intermediary to assimilate and respond to these notifications, and perform any decisions or desired follow-up actions with other devices. With the proliferation of IoT devices, the number of notifications an end-user is receiving will substantially increase. Since many of these notifications will need to be read and translated into triggers for follow-up actions by the end-users, such process needs to be streamlined in order to avoid excessive user involvements.

With the existing platforms focusing primarily on capability and functionality integration of devices, the capability of workflow automation and process streamlining are thus hindered. What is needed is an IoT platform for workflow automation that allow end-users to reduce the need of substantial human involvement, and migrate to a streamlined, trigger-driven automatic decision making operation model for IoT workflows, where end-users could either pre-define the logic of the automation or let artificial intelligence to make the decisions for them.

### SUMMARY OF THE INVENTION

Embodiments of the present invention include a computer-implemented method and a cloud-based Internet of Things (IoT) platform for workflow automation. The purpose of the embodiments of the present invention is to overcome the substantial needs for human interventions in IoT device workflows, which become unnecessary with the deployment of an embodiment of the present invention.

According to one aspect of the invention, the method includes steps of connecting an IoT platform to heterogeneous IoT devices; defining IoT workflows with the devices; decomposing the workflows into sequence of event-triggering tasks; polling the tasks over a predefined frequency; detecting whether triggering condition(s) of executing the tasks is met; and requesting the devices to perform the tasks.

The apparatus embodying features of construction, combinations of elements and arrangement of parts that are adapted to affect such steps, all is exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 illustrates one embodiment of an Internet of Things device and its service cloud which the present invention may be practiced on;

FIG. 2 is a diagram of a logic structure for an Internet of Things workflow automation platform according to an embodiment of the present invention;

FIG. 3 illustrates the architecture of a device connection management component in an Internet of Things workflow automation platform according to an embodiment of the present invention;

FIG. 4 illustrates an exemplary interaction between end-user interface of an Internet of Things workflow automation platform and some platform modules according to an embodiment of the present invention; and

FIG. 5 is a flowchart illustrating an exemplary process for creating heterogeneous Internet of Things device workflows according to an embodiment of the present invention.

### DETAILED DESCRIPTION OF THE EMBODIMENTS

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the invention. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The term “fog computing” or “fog networking” or simply a “fog” refers to an architecture or a device that uses one or more of a collaborative end-user clients or near-user edge devices to carry out a substantial amount of storage, communication, control, configuration, measurement, and management tasks, rather than putting the storage primarily in cloud data centers or managing a device over the Internet backbone.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

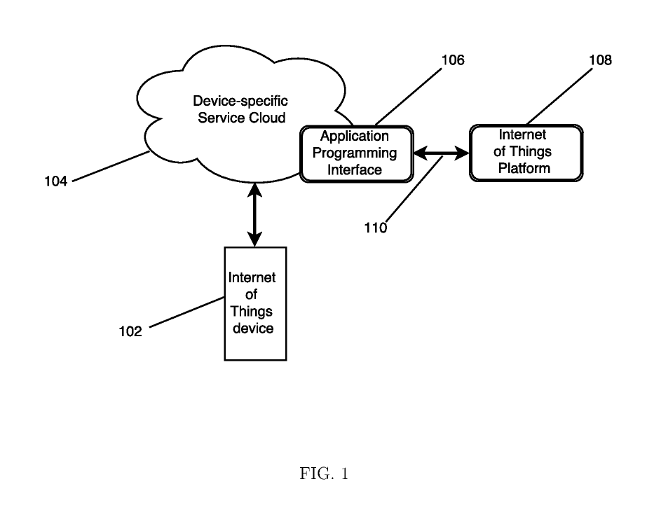

FIG. 1 illustrate an example of an IoT device 102 with its device-specific service cloud 104, and how it can be connected to an IoT platform 108. Device 102 may be connect to the Internet directly via any wired or wireless technologies (Ethernet, WiFi, Zigbee®, Z-Wave Bluetooth®, or the like), or indirectly through an intermediary (e.g., a fog) such as a mobile phone or the like, before reaching service cloud 104. Service cloud 104 comprises an application programming interface (API) 106. In some embodiments, a service cloud can have one or more APIs. API 106 adopts a software architectural style such as representational state transfer (REST) or the like, and allows third-party systems such as an IoT platform 108 to connect to service cloud 104 through a communication channel 110 using Hypertext Transfer Protocol (HTTP), Hypertext Transfer Protocol Secure (HTTPS), or the like. Service cloud 104 may require platform 108 to perform authentication when a request for connecting to service cloud 104 is made via API 106. When that happens, protocol standards such as OAuth or the like will be used for authentication over channel 110. Upon a successful authentication process, service cloud 104 will be logically linked up with platform 108. Platform 108 can now control and manage device 102 through service cloud 104, and access information provided by service cloud 104.

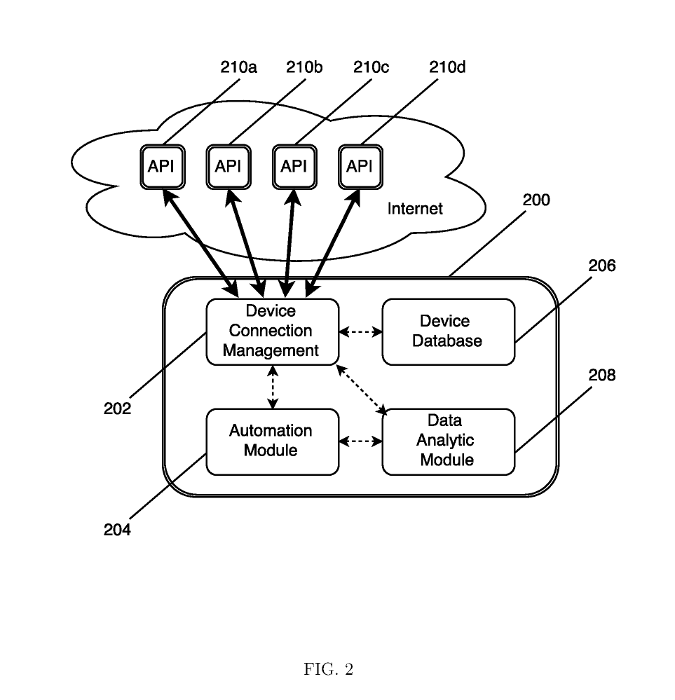

FIG. 2 is an illustration of a logic structure for an Internet of Things workflow automation platform 200 according to an embodiment of the present invention. Platform 200 comprises software modules including a device connection management component 202, an automation module 204, a device database 206, and a data analytic module 208. APIs 210a, 210b, 210c, and 210d are examples of APIs of service clouds (not shown) associated with heterogeneous smart “things” (not shown), which may include physical IoT devices, software “things” such as social media and instant messaging applications, and any sensors, wearables, or the like that has an API. Platform 200 connects to IoT devices associated with each of APIs 210a, 210b, 210c, and 210d using the same method illustrated in FIG. 1.

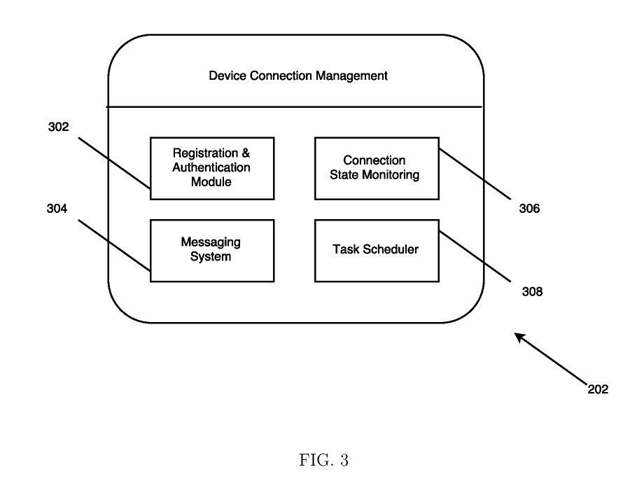

More specifically, APIs 210a, 210b, 210c, and 210d are connected to component 202 of platform 200. FIG. 3 illustrates the architecture of a device connection management component 202 according to an embodiment of the present invention. Component 202 comprises one or more of the following software module(s): a registration and authentication module 302, a messaging system component 304, a connection state monitoring component 306, and a task scheduler 308. When an end-user instructs platform 200 to connect to IoT devices associated with API 210a, module 302 will contact database 206 to obtain specific function call format and related information associated with API 210a and then initiates a connection request to API 210a. Database 206 contains a list of devices that platform 200 supports, with information including properties of the devices, function calls that the device APIs support, and other related information. If the service cloud providing APIs 210a sees that authentication is required, it will formulate a request for an identity provider it trusts, encode the request, and send the request back to platform 200 via API 210a as part of a redirect universal resource locator (URL). Module 302 of platform 200 after receiving the request will then contact the redirect URL for the identify provider with user credentials for authentication. Once the identify provider is satisfied with the authentication process, module 302 will be granted a software access token. Module 302 can use this token to communication with API 210a directly and manage the service cloud and the device associated with API 210a without going through the authentication process again, until the token expires.

Component 306 is responsible for initializing states and monitoring subsequent state changes for all connections between platform 200 and API 210a. When component 302 receives a token for connecting to API 210a, component 306 will contact database 206 to get the specifications of the device and service cloud supported by API 210a, and initialize the state of the current connection between platform 200 and API 210a and monitor and subsequent state changes. Component 306 will also pass usage statistics and other device management-related information about API 210a to module 208 for analytic purposes.

Similar operations can be applied to APIs 210b-d, and the number of APIs platform 200 can interact with is only limited by its storage and processing capacity.

Component 304 is responsible for providing commit log services and handling internal message transactions between all components and modules of platform 200. In an embodiment of the present invention, component 304 is using distributed messaging system such as Kafka or the like to carry out this function.

Scheduler 308 is responsible for scheduling interaction requests made to APIs 210a-d according to information provided by component 306, database 206, and module 204. Usage statistics and device management-related information generated by scheduler 308 is passed to module 208 for analytic purposes.

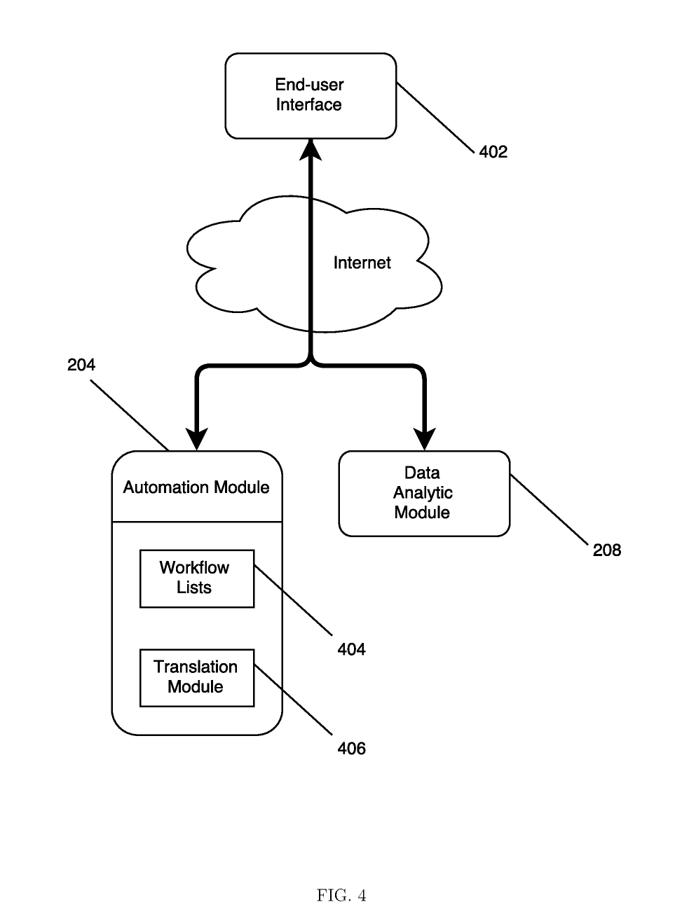

Module 204 is the logical unit responsible for providing IoT workflow automation. FIG. 4 illustrates the functional components of module 204 according to an embodiment of the present invention. Workflow lists component 404 of module 204 contains a lists of all heterogeneous IoT device workflows to be set up for automation. An IoT device workflow includes a collection of IoT devices (physical and software), and a collection of flow definitions on how the devices from the list interact with each other or with themselves. A flow definition consists of sequences tasks that are static (e.g., do a task, repeat a task every hour), conditioned (e.g., if the first task is done successfully then do the next task), or a combination of both, connecting together by boolean logic operations (AND, OR, NOT, etc.). One or a combination of the following tasks can be performed by platform 200 on an IoT device in the collection: collect information from a device, poll a device for its status, set a parameter for a device, and request a device to perform an action. The logics in a flow definition can be pre-programmed, or they can be learned dynamically by machine learning techniques or the like in order to introduce intelligence and responsiveness to the workflows.

A translation module 406 of module 204 is responsible for breaking down workflows with complex logic into a sequence of single, equivalent tasks, coupling with any triggering condition(s) if applicable. A triggering condition can be time (e.g., every hour) or an event (e.g., a button on a device is pressed). In an embodiment of the present invention, standard parsing algorithm used in interpreters is adopted for this purpose, but any alternative translation or parsing algorithms can be adopted in general. Once a workflow is decomposed into a sequence of single tasks, these tasks will be passed to scheduler 308 and be polled periodically to detect for triggering condition(s). If the condition(s) is met, the tasks will be executed automatically. Information about the workflows and decomposed tasks is passed to module 208 for analytic purposes.

FIG. 4 also illustrates an exemplary interaction between module 204 and module 208 of platform 200, and an end-user interface 402 according to an embodiment of the present invention. Interface 402 is a software running on an end-user's computing device (not shown), and is connected to platform 200 via the Internet. Interface 402 allows end-users to build and input new IoT workflows to component 404, and edit existing IoT workflows stored in component 404. Interface 402 is also responsible for receiving aggregated usage statistics and analysis from module 208 and present the information to the end-user visually.

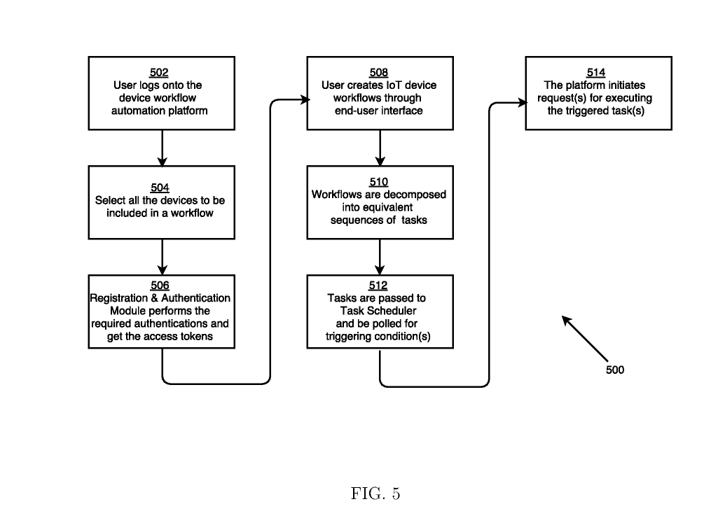

FIG. 5 is a flowchart illustrating an exemplary process 500 for creating heterogeneous IoT device workflows according to an embodiment of the present invention. In step 502, a user logs onto an IoT device workflow automation platform such as platform 200 with his or her credentials. A list of IoT devices that the user has privilege to access (including devices open for public access) and wants to include in an IoT workflow can then be selected in step 504. Step 506 is the process of obtaining access tokens for the selected devices by a registration and authentication module of the platform. A user can then create IoT device workflows with the authenticated devices through an end-user interface in step 508. Each of these IoT device workflows are decomposed into equivalent sequences of single tasks by a translation module of the platform in step 510, and the decomposed tasks are passed to a task scheduler of the platform and be polled at a predefined frequency to detect for triggering condition(s) in step 512. If any triggering condition(s) is met, the platform will initiate request(s) to the corresponding device(s) for executing the triggered task(s), without the need of human interventions, in step 514.

The reader will see that an embodiment of the IoT workflow automation platform can substantially reduce the need of human interventions, and provides a method for connecting heterogeneous IoT devices while allowing end-users to define and build streamlined and automated IoT device workflow(s) with the heterogeneous devices over wide-area networks.

While illustrative embodiments of the invention have been described in detail herein, it is to be understood that the inventive concepts may be otherwise variously embodied and employed, and that the appended claims are intended to be construed to include such variations, except as limited by the prior art.

What is claimed:

1. A computer-implemented method, comprising:
(a) connecting, via application programming interfaces, a cloud-based Internet of Things (IoT) platform to heterogeneous IoT devices;
(b) defining, via an end-user interface, IoT workflows with said devices;
(c) decomposing said workflows into sequence of event-triggering tasks;
(d) polling said tasks over a predefined frequency;
(e) detecting whether triggering condition(s) of executing said tasks is met; and
(f) requesting said devices to perform said tasks, whereby no human interventions are necessary.

2. The method of claim 1, wherein step (a) comprises authenticating, by a registration and authentication module of the platform, said devices for said platform to access and control.

3. The method of claim 1, comprising monitoring, by a connection state monitoring component of the platform, states of all connections of said devices.

4. The method of claim 1, comprising:
(a) collecting, by a data analytic module of said platform, statistics and behaviors from said devices, said workflows, and said tasks; and
(b) analyzing, by said data analytic module, statistics and behaviors collected from said devices, said workflows, and said tasks.

5. The method of claim 4, comprising displaying, via said end-user interface, analytic results from said data analytic module of said devices, said workflows, and said tasks.

6. A cloud-based Internet of Things (IoT) platform for workflow automation comprising:
(a) means for connecting said platform to heterogeneous IoT devices;
(b) means for defining IoT workflows with said devices;
(c) means for decomposing said workflows into sequence of event-triggering tasks;
(d) means for polling said tasks over a predefined frequency;
(e) means for detecting whether triggering condition(s) of executing said tasks is met; and
(f) means for requesting said devices to perform said tasks.

7. The platform of claim 6, comprising means for authenticating said devices for said platform to access and control.

8. The platform of claim 6, comprising means for monitoring states of all connections of said devices.

9. The platform of claim 6, comprising:
(a) means for collecting statistics and behaviors from said devices, said workflows, and said tasks; and
(b) means for analyzing statistics and behaviors collected from said devices, said workflows, and said tasks.

10. The platform of claim 9, comprising means for displaying analytic results of said devices, said workflows, and said tasks.

11. The platform of claim 6, comprising means for storing said workflows in computer-readable storage medium.

12. The platform of claim 6, comprising means for storing lists of IoT devices that said platform supports, with information including properties of the devices, function calls that the device APIs support, and other device-specific information.
